(19) United States
(12) Patent Application Publication
(10) Pub. No.: US 2013/0179352 A1
(43) Pub. Date: Jul. 11, 2013

(54) SECURE WIRELESS TRANSACTIONS WHEN A WIRELESS NETWORK IS UNAVAILABLE

(71) Applicant: Mocapay, Inc., Denver, CO (US)

(72) Inventors: Douglas Dwyre, Castle Pines, CO (US); James Ray, Oakland, CA (US); William O. White, Boulder, CO (US)

(73) Assignee: Mocapay, Inc., Denver, CO (US)

(21) Appl. No.: 13/736,721

(22) Filed: Jan. 8, 2013

Related U.S. Application Data
(63) Continuation-in-part of application No. 13/417,868, filed on Mar. 12, 2012.
(60) Provisional application No. 61/452,102, filed on Mar. 12, 2011.

(51) Int. Cl. G06Q 20/38

(52) U.S. Cl. CPC G06Q 20/3829; G06Q 20/206
USPC 705/71

(57) ABSTRACT

Methods, systems, and devices are disclosed for conducting offline transactions using mobile devices at a point of sale device while the point of sale device is disconnected from a network. The point of sale device may receive a request from a user for a transaction code associated with a transaction between the mobile device and a point of sale device; generate an offline transaction code based on a current offline transaction code key stored at the mobile device and a time code associated with the transaction in response to a determination that the mobile device is disconnected from a payment authority server; provide the generated offline transaction code from the mobile device to the point of sale device; and receive an indication from the point of sale device that the payment authority server has approved the transaction based on the generated offline transaction code.

### CROSS REFERENCES

The present application is a continuation-in-part of U.S. patent application Ser. No. 13/417,868 (“the '868 application”), entitled “Systems and Methods for Secure Wireless Payment Transactions when a Wireless Network is Unavailable,” filed on Mar. 12, 2012, the entire disclosure of which is incorporated herein by reference for all purposes. The '868 application claims priority under 35 U.S.C. §119 to U.S. Provisional Patent Application No. 61/452,102 (“the '102 application”), entitled “System and Method for Secure Wireless Payment Transactions When a Wireless Network is Unavailable,” filed on Mar. 12, 2011. The disclosures of the '868 application and the '102 application are incorporated herein by reference in their entirety for all purposes.

### BACKGROUND

The present invention relates generally to electronic commerce. More specifically, but not by way of limitation, the present invention relates to systems and methods for conducting wireless payment transactions when a wireless network is unavailable.

Internet and/or network connections are not ubiquitous and cannot be guaranteed to be available in all locations at all times. However, certain payment systems rely upon the availability of wireless and/or wired networks in order to complete financial transactions. When payment systems require the use of a wireless and/or wired network, the unavailability of a network may result in a failure to complete a financial transaction. Parties to a transaction cannot always accurately predict whether a network will be available when a customer is choosing to patronize a merchant. If the customer relies upon a mobile device as his or her payment method and the customer does not have access to a network (either a wired or wireless network), the merchant may be left with no other means of receiving payment for the service or goods to be purchased by the user.

Accordingly, there may be a need to provide an out-of-network option to allow the use of mobile devices to conduct payment transactions even when a wireless network is unavailable.

### SUMMARY

Systems, methods, and devices are disclosed which allow a mobile device to complete transactions with a merchant point of sale system even when the mobile device is not connected to a network.

In a first set of embodiments, a method of conducting transactions may include: receiving, at a mobile device, a request from a user for a transaction code associated with a transaction between the mobile device and a point of sale device; generating an offline transaction code based on a current offline transaction code key stored at the mobile device and a time code associated with the transaction in response to a determination that the mobile device is disconnected from a payment authority server; providing the generated offline transaction code from the mobile device to the point of sale device; and receiving an indication from the point of sale device that the payment authority server has approved the transaction based on the generated offline transaction code.

In a second set of embodiments, a method of conducting transactions at a payment authority server may include: transmitting an offline transaction code key to a mobile device; receiving, from a point of sale device, an offline transaction code and a transaction amount during a period of disconnection between the payment authority server and the mobile device; linking the offline transaction code to the mobile device based on the offline transaction code key; and authorizing the transaction amount to the point of sale device based on at least one account associated with a user of the mobile device.

In a third set of embodiments, a mobile device may include a processor and a memory communicatively coupled with the processor. The memory may store instructions executable by the processor to: receive, at a mobile device, a request from a user for a transaction code associated with a transaction between the mobile device and a point of sale device; generate an offline transaction code based on a current offline transaction code key stored at the mobile device and a time code associated with the transaction in response to a determination that the mobile device is disconnected from a payment authority server; provide the generated offline transaction code from the mobile device to the point of sale device; and receive an indication from the point of sale device that the payment authority server has approved the transaction based on the generated transaction code.

In a fourth set of embodiments, a mobile device may include a processor and a memory communicatively coupled with the processor. The memory may store instructions executable by the processor to: transmit an offline transaction code key to a mobile device; receive, from a point of sale device, an offline transaction code and a transaction amount during a period of disconnection between the payment authority server and the mobile device; link the offline transaction code to the mobile device based on the offline transaction code key; and authorize the transaction amount to the point of sale device based on at least one account associated with a user of the mobile device.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention;

FIG. 2 is a block diagram showing example interactions among various entities during one or more transactions, according to various embodiments of the invention;

FIG. 3 is a block diagram illustrating example interactions among various entities during an example transaction, according to various embodiments of the invention;

FIG. 4 is a block diagram of an example mobile device that may be used in various embodiments of the present invention;

FIG. 5 is a diagram of an example system for conducting transactions configured according to various embodiments of the invention;

FIG. 6 is a block diagram of an example payment authority server that may be used in various embodiments of the present invention;

FIG. 7 is a diagram of an example system for conducting transactions configured according to various embodiments of the invention;

FIG. 8 is a flow chart of a portion of an example method for conducting an offline transaction from the perspective of a mobile device, according to various embodiments of the invention;

FIG. 9 is a flow chart of a portion of another example method for conducting an offline transaction from the perspective of a mobile device, according to various embodiments of the invention;

FIG. 10 is a flow chart of a portion of an example method for conducting an offline transaction from the perspective of a payment authority server, according to various embodiments of the invention; and

FIG. 11 is a flow chart of a portion of an example method for conducting an offline transaction from the perspective of a payment authority server, according to various embodiments of the invention.

### DETAILED DESCRIPTION OF THE INVENTION

In the systems, methods, and devices of the present application, a mobile device may periodically receives offline transaction code keys from a payment authority server over a network connection. When the mobile device becomes disconnected from the payment authority server, the mobile device may generate an offline transaction code based on the locally stored offline transaction code key and a current time code. The offline transaction code may be transmitted or otherwise provided to a point of sale device, which may forward the offline transaction code to a payment authority server to authorize the transaction.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used in the present disclosure and appended claims, the term “merchant” is to be broadly construed as a provider of goods and services.

As used in the present disclosure and the appended claims, the term “transaction code” refers broadly to an alphanumeric, binary, or other type of code provided by a mobile device to obtain authorization of a pending transaction without disclosing an account number.

As used in the present disclosure and the appended claims, the term “offline transaction” refers to a transaction between a mobile device and a point of sale system during which either the mobile device or the point of sale system is disconnected from a payment authority system.

A mobile payment card, for the purposes of discussion in this application, refers to any of the items in the mobile device-side wallet that can include gift card numbers, credit or debit card numbers, and the like as such numbers are stored in the server-side digital wallet. A “mobile payment card” is, thus, a digital construct (stored digital data) that replaces a physical (e.g., plastic, magnetically encoded) payment card.

A mobile-payment-card platform in accordance with these illustrative embodiments may provide, among other things, a server-side digital wallet and a mobile device-side wallet for mobile payment cards that overcomes the shortcomings (e.g., risk of loss or theft) associated with other payment methods that reside within the mobile device itself. The server-side digital wallet, the mobile device-side wallet and the relationship between the two are described more fully in U.S. Pat. No. 7,657,489, the specification of which is incorporated in its entirety herein.

In these illustrative embodiments, credentials (account numbers, balances, or other sensitive information) associated with a user's payment methods may reside somewhere other than the mobile device itself A secure network infrastructure may distribute and manage the payment methods and their associated credentials, the mobile device acting merely as one means for the user to communicate with the server-side digital wallet and the merchant system to access a variety of flexible services surrounding use of the mobile payment methods. The merchant system may include, but is not limited to, the point of sale devices, computers, networks and back end systems for managing the merchant's business.

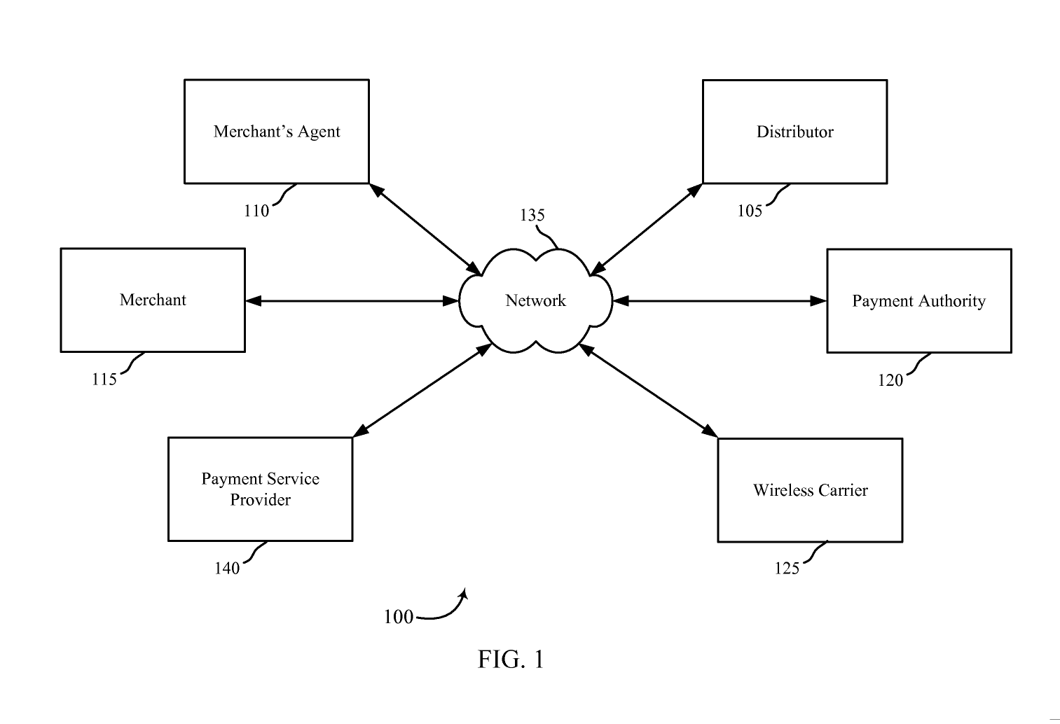

FIG. 1 illustrates a functional block diagram of a system 100 in which various illustrative embodiments of the invention can be implemented. In system 100, distributor 105, merchant's agent 110, merchant 115, payment authority 120, wireless carrier 125, and payment service provider 140 may be able to communicate with one another via network 135. A user's mobile device—e.g., a cellular or Personal Communication Service (PCS) phone—may also be able to communicate with nodes connected with network 135 via wireless carrier 125. In some embodiments, network 135 includes, but is not necessarily limited to, the Internet.

It will be understood that the wireless network utilized by the mobile device referred to herein may be a cellular communication network such as a GSM network, a COMA network, a 3G network, a 4G network, WiFi, WiMAX, etc. Further, it will be understood that the mobile device can communicate with the payment card management platform via the Internet or the World Wide Web. Also, the mobile device may connect to the payment card management platform via one or more wired or wireless Metropolitan Area networks (MANs); one or more wired or wireless local area networks (LANs); one or more wired or wireless Wide Area networks (WANs); one or more wired or wireless Personal Area networks (PANs); etc. Further, it will be understood that the various components are configured to communicate using the requisite communication protocols and signal schemes.

The system 100 in FIG. 1 may build on existing payment systems operated by payment service providers 140 such as, without limitation, MOCAPAY, FIRST DATA and COMDATA. Payment service provider 140, among other things, may administer the financial aspects of payment cards or other accounts, including keeping track of the balance associated with a particular payment method, settlement, reporting to merchants, and other functions.

Merchant 115 may sell goods, services, or both to consumers either directly or with the assistance of merchant's agent 110. For example, merchant's agent 110 may facilitate the distribution and sale of payment cards issued by merchant 115 by acting as an intermediary between merchant 115 and any of the following: (1) a payment-card service provider 140, (2) mobile-payment-card distributors 105, (3) mobile-payment-card purchasers (those giving the mobile payment cards to others), and (4) mobile-payment-card recipients (consumers who use the mobile payment cards in commerce). A consumer holding such a mobile payment card can use the mobile device to purchase goods or services from the particular merchant that issued the mobile payment card, as explained above. How the holder of a mobile payment card uses the mobile device to make purchases from the issuing merchant is discussed further below. As should be understood from one skilled in the art, the use of the mobile device described herein is not limited to the strict use of a physical card or an account with a cash balance, but may also include the use of loyalty accounts, coupons, gift cards, or other incentives.

Payment authority 120 may be the source of funds for transactions carried out from a user's mobile device such as the user's reloading of a mobile payment card or purchase of a mobile payment card on behalf of someone else. In such transactions, payment authority 120 may act as an agent of the merchant to collect funds from the user's credit card or other payment source. In some examples, an entity acting as a payment authority 120 in certain contexts may also be a distributor 105 in other contexts.

Distributor 105 may market mobile payment cards and, in some embodiments, may be somewhat analogous to an entity such as a grocery store chain which markets conventional plastic, magnetically encoded payment cards for a variety of other merchants on racks in its grocery stores with the assistance of a conventional-payment-card merchant's agent. Distributor 105 can take on a variety of different forms, depending on the particular embodiment.

In one example, distributor 105 may be an entity (not necessarily a merchant) that operates a Web site or other electronic communication channel where payment cards for a number of different merchants are offered in an aggregated fashion. In another embodiment, a single merchant markets its payment cards via remote distribution channels, local distribution channels, or both. For example, a merchant may market its payment cards via a remote distribution channel such as a Web site or other networked electronic communication channel using Application Programming Interfaces (AP's) supplied by merchant's agent 110 or another entity. That is, a merchant may use flexible APIs provided by merchant's agent 110 to customize a Web site or other networked electronic communication channel to offer its payment cards in a manner consistent with the merchant's particular brand identify, logos, etc. A merchant may also employ local distribution methods in a store (at the point of sale). In such examples, the payment card can be “mobilized” (made accessible to the recipient via the recipient's mobile device) at the point of sale.

In yet another embodiment, distributor 105 may be a social networking Web site where the interests and preferences of a potential mobile-payment-card recipient are revealed to that person's friends and family. For example, John may discover on a social networking web site that his friend Alan likes to shop at a particular merchant, and John can purchase a mobile payment card for that merchant at the social networking site for Alan. The above are merely a few examples of distributors 105. Mobile payment cards can be marketed in a wide variety of ways and settings.

In an illustrative embodiment, merchant 115 receives the funds from a user's purchase of a mobile payment card minus a predetermined fee that is paid to the merchant's agent 110.

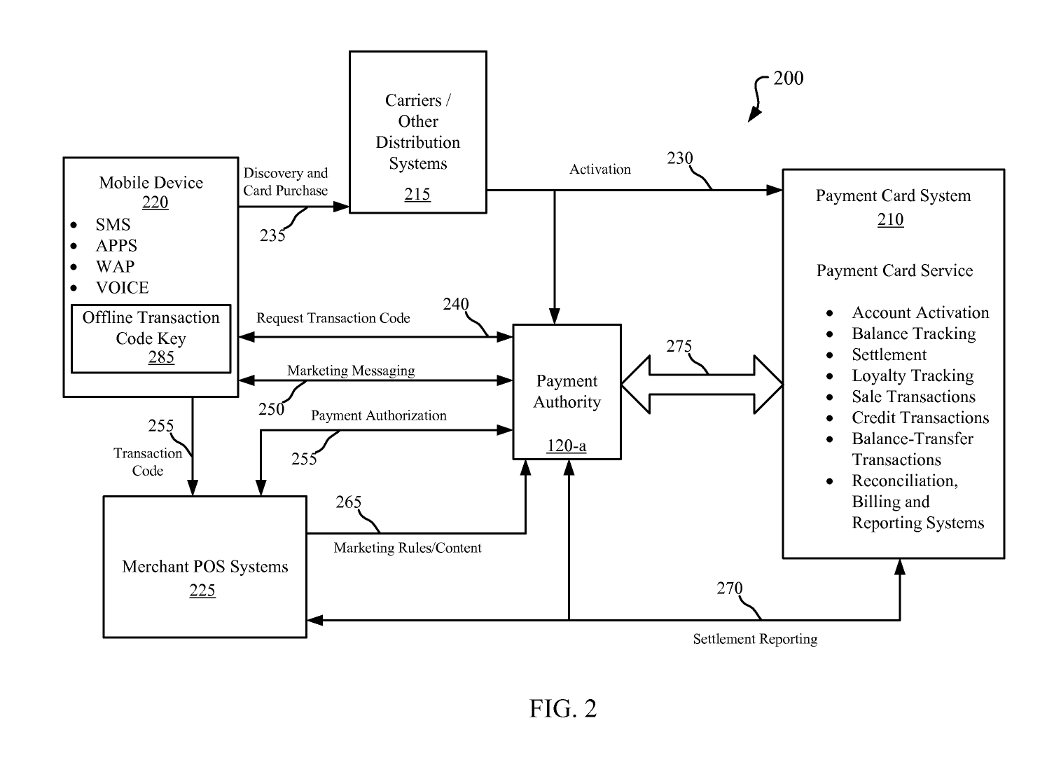

FIG. 2 shows example interactions among various entities involved in the distribution and use of mobile payment accounts in a system 200, in accordance with an illustrative embodiment of the invention. In FIG. 2, payment card system 210 may include a system operated by a conventional payment-card service provider 140 such as, without limitation, FIRST DATA or COMDATA. Various embodiments of the invention preserve the existing payments infrastructure supporting the use of payment cards or other types of payment accounts and overlay them with a payment authority 120-a, which is explained below. Other entities involved are a merchant point of sale system 225, a mobile device 220, and carriers or other entities (“CARRIERS/OTHERS” in FIG. 2) 215 and their associated distribution systems (see distributor 105 in FIG. 1). In the discussion of FIG. 2 below, interactions among these entities are identified by their corresponding reference numerals in parentheses.

In some embodiments, mobile device 220 can use a variety of different access methods such as, without limitation, Short Message Service (SMS) messages, Multimedia Message Service (MMS) messages, Wireless Access Protocol (WAP), an application, or voice to obtain perishable transaction codes 240 from payment authority 205 in making payments from a variety of different tenders (forms of payment), including mobile payment cards. Mobile device 220 can also use a variety of methods, including Near Field Communications (NFC) and any of the above examples, to provide one-use perishable transaction codes to merchant point of sale systems 225 in making electronic purchases 260.

For example, mobile device 220 may receive a transaction code 240 as evidence of pre-authorization by payment authority 205 for a specific transaction. Mobile device 220 may provide the transaction code 240 to a merchant point-of-sale (POS) system 225 to pay for a transaction via NFC communications or another method, and the merchant POS system 225 may receive payment authorization from the payment authority based on the transaction code. Additional details and examples regarding the use of perishable transaction codes 240 can be found, for example, in the aforementioned '489 patent.

A user of mobile device 220 may also receive targeted marketing messages 250 before, during, or after a mobile purchase via payment authority 205 and may purchase 235 mobile payment cards from a carrier 215 or other distributor 105 such as a social networking Web site. The targeted marketing messages may be assisted by the ability of merchant point of sale system 225 to submit marketing rules, content, or both 265 to payment authority 205.

Payment authority 205 may be an example of payment authority 120 described above with reference to FIG. 1. Payment authority 120-a may facilitate the activation 230 of mobile payment cards sold by a carrier or other entity 215 (or other distributor 105) in cooperation with payment card system 210 via communication link 275. Payment card system 210 may also provide, among other things, settlement and reporting services 270 to the merchant.

When the user of mobile device 220 in communication with the payment authority 120-a wishes to make a purchase transaction using a mobile payment account associated with payment authority 120-a, mobile device 220 may contact payment authority 120-a using any of a variety of access methods (e.g., SMS, MMS, WAP, HTTP, or other browser technology, application, voice) to provide an optional personal identification number (PIN) or other authentication credential by which payment authority 120-a may authenticate mobile device 220. Payment authority 120-a may provide mobile device 220 with one or more one-time perishable (time-limited) transaction codes 240 and balances for various tenders available to that user, including mobile payment cards. In the present example, the user of mobile device 220 may select a specific mobile payment card or other account to be used in making the purchase.

The user of the mobile device 220 may provide 260 the received transaction code associated with the selected tender to the merchant point of sale system 225. If the mobile-payments-enabled merchant point of sale system 225 is connected to the payment authority 120-a at the time of the purchase transaction, the point of sale system 225 may submit 255 the transaction code provided by mobile device 220 and the transaction amount to payment authority 120-a. Payment authority 120-a may route the transaction parameters to payment card system 210, which may ensure that the requested amount is available from the selected tender. If everything checks out, payment card system 210 may inform payment authority 120-a, which, in turn, conveys a return authorization to the merchant point of sale system 225, completing the transaction.

However, a network connection to the payment authority 120-a may not always be available to the mobile device 220. For example, the mobile device 220 may connect to the payment authority 120-a over a wireless or cellular network, and channel conditions, the location of the mobile device 220, or other network issues may prevent the mobile device 220 from accessing the network.

For at least this reason, mobile device 220 may periodically receive and locally store offline transaction code keys 285, which may be used to generate offline transaction codes for offline purchases or other transactions when a connection to the payment authority 120-a is lost. The offline transaction codes may be transmitted 255 to the merchant point of sale system 225, and the merchant point of sale system 225 may receive authorization for the offline transactions from the payment authority 120-a. Each offline transaction code may be generated by encrypting at least a current time code with the offline transaction code key 285 most recently received for a selected account at the mobile device 220. The payment authority 120-a may recognize the offline transactions generated by the disconnected mobile device 220 based on the offline transaction code key and the current time code, link the generated offline transaction code to the mobile device 220 and the selected account, and approve the transaction according to a balance of the selected account.

Thus, instead of relying solely on transaction codes generated on the fly by the payment authority 120-a, the mobile device 220 may generate its own transaction codes to authorize payment to the merchant when the mobile device 220 is disconnected from the payment authority 120-a.

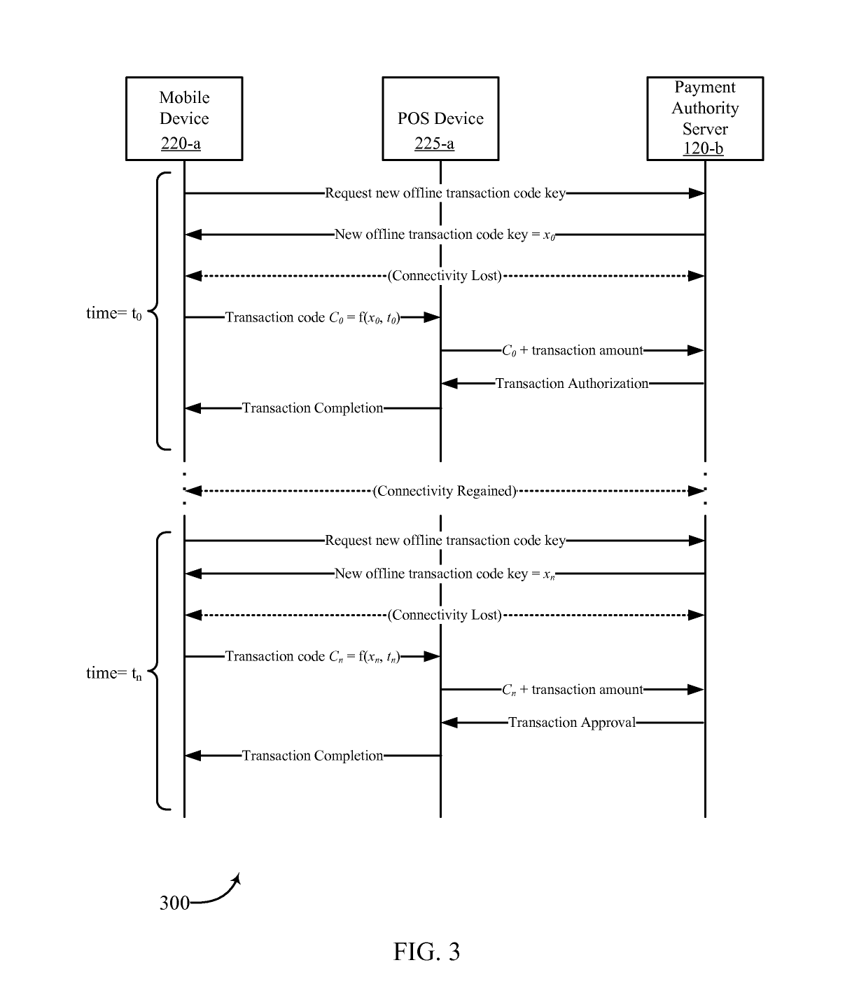

FIG. 3 is a diagram of example transaction interactions in a system 300 including a mobile device 220-a, a point of sale device 225-a, and a payment authority server 120-b to authorize a transaction (e.g., a purchase of goods or services) between the mobile device 220-a and the point of sale device 225-a. The mobile device 220-a may be an example of the mobile device 220 of FIG. 2. The point of sale device 225-a may be an example or component of the point of sale system 225 of FIG. 2, and the payment authority server 120-b may be an example or component of the payment authority 120 of FIGS. 1 and 2.

As shown in FIG. 3, the passage of time may be measured according to time windows synchronized across the devices 220-a, 225-a, 120-b. Each of these time windows may be associated with a time code. In the present example, a first window of time may be assigned time code t₀, and a later window of time may be assigned time code tₙ. However, it will be understood that any time code scheme for identifying windows of time across the devices may be used.

In the present example, at time code t₀, mobile device 220-a may request a new offline transaction code key from payment authority server 120-b over a network connection. The mobile device 220-a may be configured to periodically request a new offline transaction code key (e.g., every 10 minutes) during a period of connection to the payment authority server 120-b. The payment authority server 120-b may respond with new offline transaction code key x₀. The transaction code key may be stored locally at mobile device 220-a and payment authority server 120-b. After losing connectivity to the payment authority server 120-b, a user of the mobile device may wish to conduct a purchase transaction with the point of sale device 225-a. Accordingly, the mobile device 220-a may generate offline transaction code C by performing encryption function f, known to both the mobile device 220-a and the payment authority server 120-b, on current time code t₀ using key x₀.

In certain examples, an offline transaction code may be generated at the mobile device 220-a automatically at the beginning of each time window associated with a new time code. Alternatively, the offline transaction code may be generated on demand in response to a request from the user for a transaction code during the period of disconnection with the payment authority server 120-b. In certain examples, additional operands may be encrypted with the time code t₀ to generate the offline transaction code C₀. For example, the transaction code C may be further based on an amount of the requested transaction, an identity of the user, an identity of the merchant, a selected payment account, and/or other parameters.

The mobile device 220-a may provide the generated offline transaction code C₀ to the point of sale device 225-a in connection with the offline transaction, and the point of sale device 225-a may forward the generated offline transaction code C₀ to the payment authority server 120-b together with a transaction amount. The payment authority server 120-b may recognize transaction code C₀ as having been generated using offline transaction code key x₀ and the time code for the current window of time. Accordingly, the payment authority server 120-b may link the transaction code C₀ to the mobile device 220-a and authorize the transaction to the point of sale device 225-a based on an account balance associated with a user of the mobile device 220-a. The point of sale device 225-a may in turn transmit an indication to the mobile device 220-a that the transaction has been authorized by the payment authority server 120-b and complete the transaction. The payment authority server 120-b may generate settlement instructions to transfer funds or other credit from the account associated with the mobile device user to the merchant associated with the point of sale device 225-a.

In the present example, connectivity between the mobile device 220-a and the payment authority server 120-b may be regained between time codes t₀ and tₙ. At the beginning of the time window associated with time code tₙ, a timer for updating the offline transaction code key may expire at the mobile device 220-a, and the mobile device 220-a may request a new offline transaction code key from the payment authority server 120-b. The payment authority server 120-b may transmit new offline transaction code key xₙ to the mobile device 220-a, which may replace x₀ with xₙ as the current offline transaction code key. In certain examples, if the mobile device 220-a is disconnected from the payment authority server 120-b when the timer for updating the offline transaction code key expires, the mobile device 220-a may continue to use its current offline transaction code key to generate offline transaction codes until connectivity to the payment authority server 120-b is restored and the mobile device 220-a is able to request a new offline transaction code key.

In the present example, connectivity between the mobile device 220-a and the payment authority server 120-b may be lost again during time code t₀, and the user of the mobile device 220-a may request a transaction code for a new offline purchase transaction with point of sale device 225-a. The mobile device 220-a may generate transaction code Cₙ by encrypting time code tₙ using the new offline transaction code key xₙ. The transaction code Cₙ may be transmitted from the mobile device 220-a to the point of sale device 225-a, and forwarded to the payment authority server 120-b from the point of sale device 225-a in connection with the requested transaction amount. The payment authority server 120-b may recognize the offline transaction code Cₙ, link the offline transaction code Cₙ to the mobile device 220-a, and approve the transaction to the point of sale device 225-a based on the balance of the account associated with the user of the mobile device 205-a.

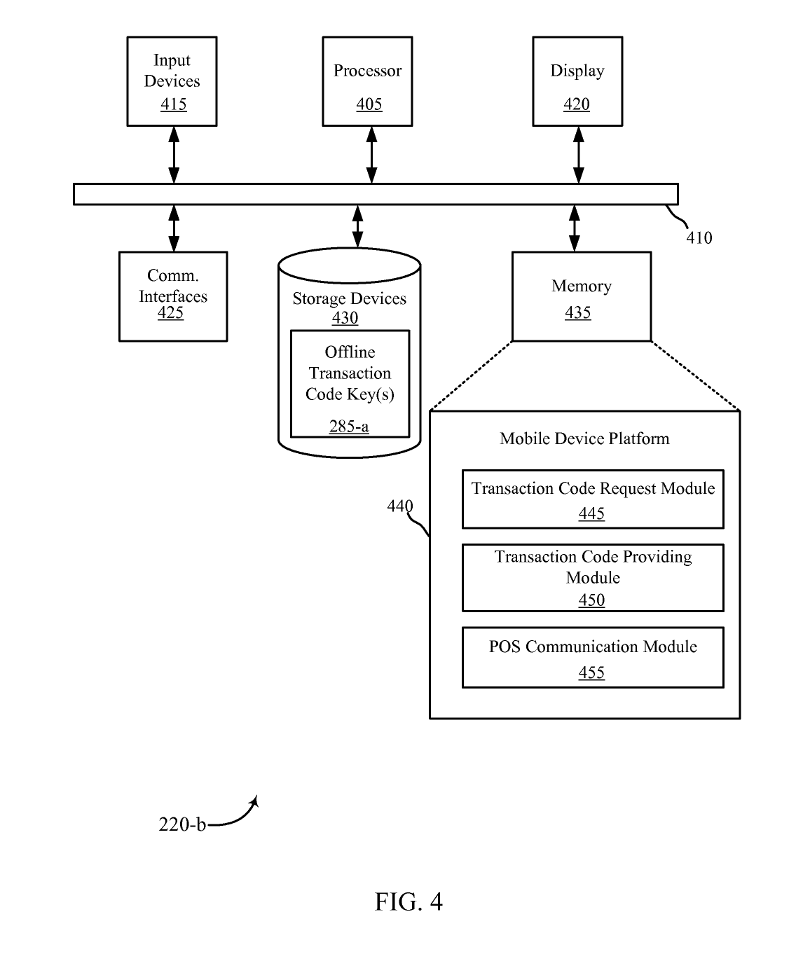

FIG. 4 is a functional block diagram of one example of a mobile device 220-b according to the principles of the present description. The mobile device 220-b may be an example of one or more of the mobile devices 220 of FIG. 2. In the present example, processor 405 communicates over data bus 410 with input devices 415, display 420, communication interfaces 425, storage devices 430 (e.g., hard disk drives, floppy disk drives, optical drives, flash memory, etc.), and memory 435. Though FIG. 4 shows only a single processor, multiple processors or a multi-core processor may be present in some embodiments.

Input devices 415 may include, for example, a keyboard, a mouse or other pointing device, or other devices that are used to input data or commands to processor 405 to control the operation of the mobile device 220-b. Communication interfaces 425 may include, for example, various serial or parallel interfaces for communicating with a network 135 (see FIG. 1) or one or more peripherals.

Memory 435 may include, without limitation, random access memory (RAM), read-only memory (ROM), flash memory, magnetic storage (e.g., a hard disk drive), processors, optical storage, or a combination of these, depending on the particular embodiment. In FIG. 4, memory 435 may contain code that, when executed by processor 405, causes processor 405 to implement a mobile device platform 440 which conducts transactions on behalf of a user with a point of sale system and locally generates offline transaction codes for the transactions when the mobile device 220-b is disconnected from a network according to the principles described herein.

The mobile device platform 440 implemented by the mobile device 220-b may include at transaction code request module 445, transaction code providing module 450, and point of sale communication module 455. Transaction code request receiving module 445 may be configured to receive a request from a user of the mobile device (e.g., through a software application running on the processor 405) for a transaction code associated with a transaction between the mobile device 220-b and a point of sale device.

The transaction code providing module 450 may, in response to determining that the mobile device 220-b is disconnected from a payment authority server, generate an offline transaction code based on a current offline transaction code key 285-a stored at the mobile device 220-b and a current time code known by both the mobile device 220-b and the payment authority server.

The point of sale communication module 455 may transmit the generated offline transaction code or otherwise make the generated offline transaction code available to the point of sale device. In certain examples, the offline transaction code may be generated by encrypting at least the current time code using the stored offline transaction code key and an encryption function known to both the mobile device 220-b and the payment authority server. The point of sale communication module 455 may additionally receive an indication from the point of sale device that the payment authority server has approved the transaction based on the generated offline transaction code.

In certain examples, the mobile device platform 440 may be further configured to request and receive an updated offline transaction code key from the payment authority server in response to reconnecting to the payment authority server over a network. Such updates may occur periodically during periods of continuous connection between the mobile device 220-b and the payment authority server. In certain examples, when a new or updated offline transaction code key is received from the payment authority server, the mobile device platform may mark the current offline transaction code key as expired and replace the expired transaction code key with the new or updated offline transaction code key.

In certain examples, the transaction code request module 445 of the mobile device platform 440 may authenticate an identity of the user at the mobile device prior to allowing the transaction to move forward. For example, the user may be prompted to enter a Personal Identification Number (PIN) or other authentication credential in connection with the user's request for the offline transaction code in order to verify the user's identity prior to providing the generated offline transaction code to the payment authority server.

In certain examples, a number of different payment accounts may be associated with the user of the mobile device, and the mobile device 220-b may store a separate offline transaction code key for each of the payment accounts. In this way, the user may select a payment account for a particular transaction, and the payment authority server may link the transaction to a specific account based on the offline transaction code generated by the mobile device 220-b. In certain examples, the time code associated with the transaction may be based on a current window of time, and the offline transaction code may expire at the end of the current window of time with the current time code.

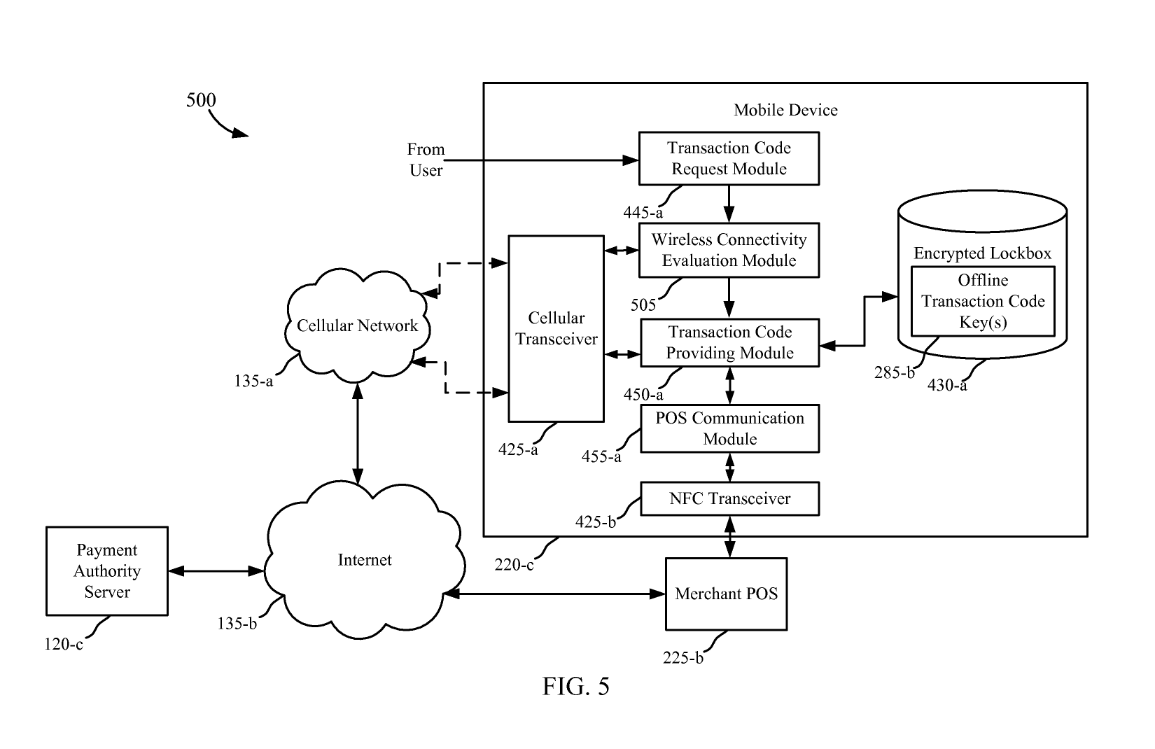

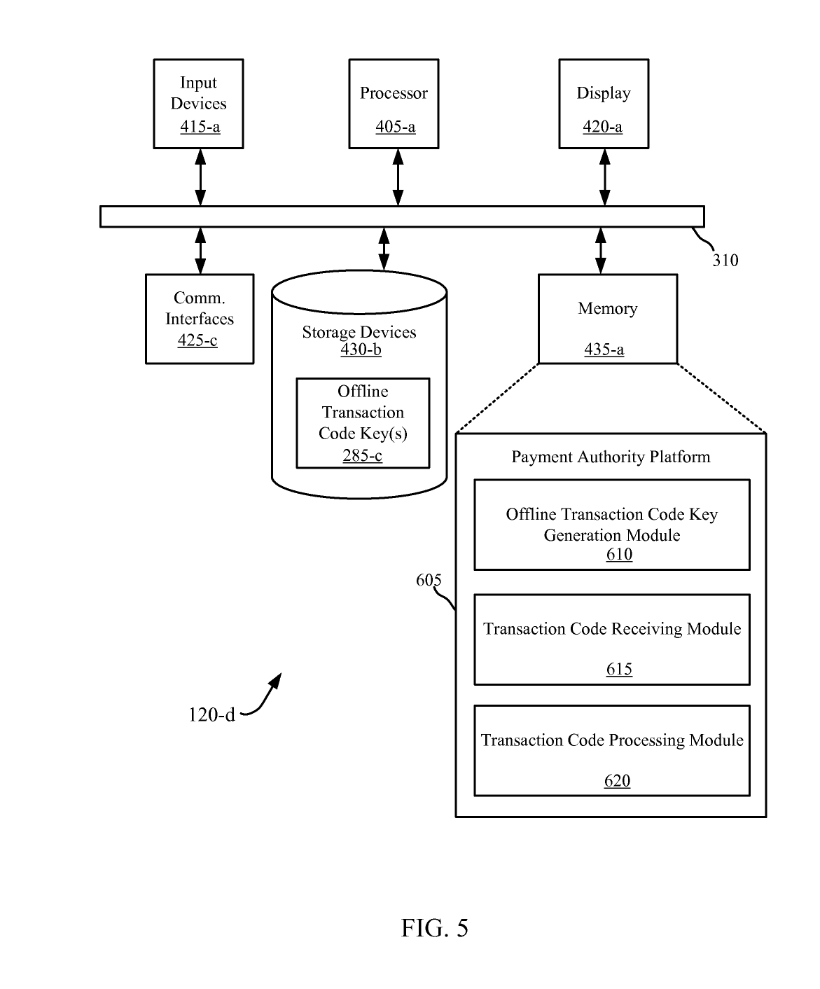

FIG. 5 is a block diagram of an example system 500 for conducting a transaction according to the principles of the present description. System 500 may be an example of one or more of the systems 100, 200, 300 described above with respect to previous Figures. System 400 may include a payment authority server 120-c, a cellular network 135-a, the Internet 135-b, mobile device 220-c, and merchant point of sale (POS) device 225-b. Each of these elements of the system may be in communication with each other, directly or indirectly.

Payment authority server 120-c may be an example of one or more of the payment authorities 120 described above with reference to previous Figures. The cellular network 135-a and the Internet 135-a may be examples of network 135 described above with reference to FIG. 1 or a network used to interconnect the components of FIG. 2. Mobile device 220-a may be an example of one or more of the mobile devices 220 described in the previous Figures. Merchant point of sale terminal 225-b may be an example or component of the merchant POS system(s) 225 described above with reference to previous Figures.

In the present example, the mobile device 220-c may include transaction code request module 445-a, wireless connectivity evaluation module 505, transaction code providing module 450-a, POS communication module 455-a, cellular transceiver 425-a, NFC transceiver 425-b, and an encrypted lockbox data store 430-a configured to store one or more offline transaction code keys 285-b received from the payment authority server 120-c. The transaction code request module 445-a, transaction code providing module 450-a, and point of sale communication module 455-a may be examples of their respective counterparts described in FIG. 4. The cellular transceiver 425-a and NFC transceiver 425-b may be examples of the communication interfaces 425 of FIG. 4, and the encrypted lockbox data store 285-b may be an example one or more of the storage devices 430 of FIG. 4.

As described in the above examples, a user of the mobile device 220-c may request a transaction code for a transaction with the merchant point of sale device 225-b. This request may be received at the transaction code request module 445-a. The wireless connectivity evaluation module 505 may determine whether a connection to the payment authority server 120-c is available over the cellular network 135-a and the Internet 135-b.

While mobile device 220-c is connected to cellular network 135-a and the user of mobile device 220-c wishes to conduct a transaction, the transaction code providing module 450-a may request and receive a dynamically generated perishable transaction code from the payment authority server. The perishable transaction code may be associated with the specific transaction. The point of sale communication module 455-a may forward the received perishable transaction code to the merchant point of sale device 225-b over NFC transceiver 425-b. In other examples, the mobile device 220-c may communicate with the merchant point of sale device using a different wireless protocol (e.g., Bluetooth, Wi-Fi, by way of the user, etc.). The point of sale device 225-b may route the perishable transaction code to payment authority server 120-c over the Internet 135-b together with a transaction amount and other information (e.g., merchant identifier, time, date, a unique mobile device identifier, mobile device phone number, etc.). The payment authority server 120-c may approve or reject the transaction based on one or more of the parameters received from the point of sale device 225-b, including, but not limited to, the transaction code, the transaction amount, the merchant identifier, the time, the date, the mobile device identifier or phone number, and/or other parameters. Upon approval or rejection of the transaction by the either payment authority server 120-c, the transaction may be either completed or canceled.

On the other hand, if no connectivity to cellular network 135-a exists at the time the transaction code is requested, the transaction code providing module 450-a may generate an offline transaction code using one or more of the stored offline transaction code keys 285-b previously received from the payment authority server 120-c. The locally generated offline transaction code may then be forwarded to the merchant point of sale device 225-b by the point of sale communication module 455-a over NFC transceiver, and the merchant point of sale device 225-b may forward the locally generated offline transaction code to the payment authority server 120-c over the Internet 135-b for approval or rejection.

FIG. 6 is a functional block diagram of one example of a payment authority server 120-d according to the principles of the present description. The payment authority server 120-d may be an example or component of one or more of the payment authorities 120 described in the previous Figures. In the present example, processor 405-a may communicate over data bus 410-a with input devices 415-a, display 420-a, communication interfaces 425-c, storage devices 430-b (e.g., hard disk drives, floppy disk drives, optical drives, flash memory, etc.), and memory 435-a. Though FIG. 6 shows only a single processor, multiple processors or a multi-core processor may be present in some embodiments.

Input devices 415-a may include, for example, a keyboard, a mouse or other pointing device, or other devices that are used to input data or commands to processor 405-a to control the operation of the payment authority server 120-d. Communication interfaces 425-c may include, for example, various serial or parallel interfaces for communicating with a network 135 (see FIGS. 1, 5) or one or more peripherals.

Memory 435-a may include, without limitation, random access memory (RAM), read-only memory (ROM), flash memory, magnetic storage (e.g., a hard disk drive), processors, optical storage, or a combination of these, depending on the particular embodiment. In FIG. 5, memory 435-a may contain code that, when executed by processor 405-a, causes processor 405-a to implement a payment authority platform 605 which interacts with mobile devices (e.g., one or more of the mobile devices 220 of the previous Figures) and point of sale devices (e.g., one or more of the point of sale devices 225 of the previous Figures) to authorize and settle transactions using payment accounts or other accounts associated with user of the mobile devices, according to the principles described herein.

The payment authority platform 605 implemented by the payment authority server 120-c may include offline transaction code key generation module 610, transaction code receiving module 615, and transaction code processing module 620. Offline transaction code key generation module 610 may generate offline stand-in transaction code keys specific to a mobile device and transmit the generated offline transaction code keys periodically or upon request to the mobile device. A copy of the offline transaction code keys 285-c may also be stored at a location that is accessible to the payment authority server 120-d.

When a point of sale device requests authorization for a transaction with the mobile device during a period of disconnection between the mobile device and the payment authority server 120-d, the point of sale device may transmit an offline transaction code received from the mobile device and a transaction amount to the payment authority server 120-d. The transaction code may be received from the point of sale device at the transaction code receiving module 615. The transaction code processing module 620 may link the offline transaction code to the mobile device based on the offline transaction code key used to generate the offline transaction code, and authorize the transaction amount to the point of sale device based on at least one account associated with a user of the mobile device. The transaction code processing module 620 may transmit an authorization code or similar indication of the approval status of the transaction to the point of sale device.

In certain examples, following the transmission of an offline transaction code key 285-c to the mobile device, the payment authority server 120-d ay compute a local copy of a current offline transaction code for the mobile device based on the offline transaction code key 285-c transmitted to the mobile device. The transaction code processing module 620 may then link the received offline transaction code from the point of sale device to the mobile device based on a comparison of the local copy of the offline transaction code and the received copy of the transaction code.

In certain examples, the offline transaction code may be an encryption of a current time code known to the mobile device and the payment authority server 120-d using the offline transaction code key transmitted to the mobile device. The time code may be associated with a current window of time, and the offline transaction code key may expire at the end of the current window of time. In examples where the payment authority server 120-d stores local copies of offline transaction codes for the mobile device, the local copy of a current offline transaction code may be marked as expired at the end of the current window of time associated with the current time code. Additionally or alternatively, the offline transaction code may expire after a predetermined period of time following its generation.

In certain examples, the offline transaction code key generation module 610 may generate a separate offline transaction code key to the mobile device for each of a number of payment accounts associated with the user of the mobile device. In these examples, the transaction code processing module may authorize transactions associated with received offline transaction codes by identifying a selected account of the user based on the received offline transaction code and determining whether a balance of the selected account is sufficient to cover the transaction amount.

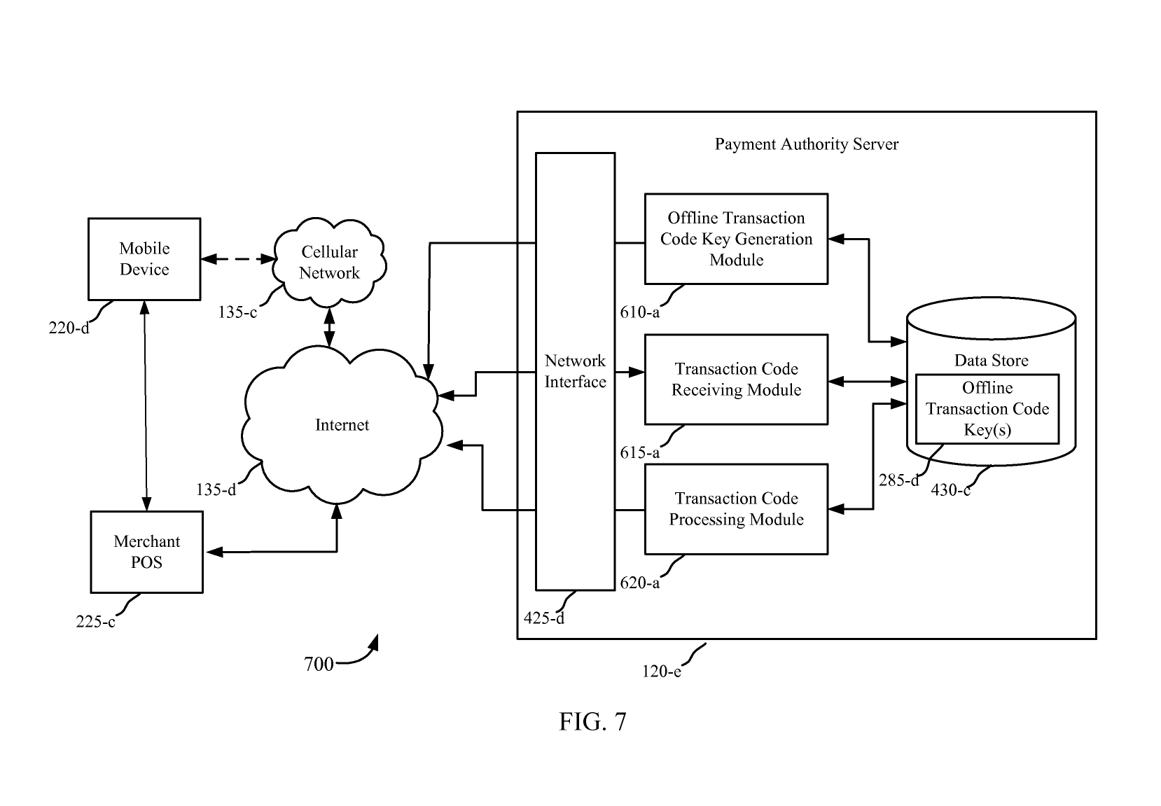

FIG. 7 is a block diagram of an example system 700 for conducting a transaction according to the principles of the present description. System 700 may be an example of one or more of the systems 100, 200, 300, 500 described above with respect to the previous Figures. System 700 may include a payment authority server 120-e, cellular network 135-c, the Internet 135-d, mobile device 220-d, and merchant point of sale (POS) device 225-c. Each of these components of the system 700 may be in communication with each other, directly or indirectly.

Payment authority server 120-e may be an example of one or more of the payment authorities 120 described above with reference to previous Figures. The cellular network 135-b and the Internet 135-c may be examples of one or more of the networks 135 described above with reference to previous Figures. Mobile device 220-d may be an example of one or more of the mobile devices 220 of previous Figures. Merchant point of sale terminal 225-c may be an example or component of one or more of the merchant POS system(s) 225 described above with reference to previous Figures.

In the present example, the payment authority server 120-e may include network interface 425-d, offline transaction code key generation module 610-a, transaction code receiving module 615-a, transaction code processing module 620-a, and data store 430-c, which may stores online transaction codes, offline transaction code keys 360-b generated for one or more mobile devices, and current offline transaction codes based on the offline transaction code keys.

As described in the above examples, when the mobile device 220-d is connected to cellular network 135-c, the mobile device 220-d may communicate with payment authority server 120-e over cellular network 135-c and the Internet 135-d to request a transaction code for a transaction with a merchant associated with a merchant point of sale device 225-c. The mobile device 220-d may transmit the transaction code received from the payment authority server to the merchant point of sale 225-c, which may forward the transaction code and a transaction amount (and, in certain examples, one or more other parameters related to the transaction) to the payment authority server 120-e. The transaction code receiving module 615-a may receive the transaction code and the transaction code processing module 620-a may approve or reject the transaction based on at least the received transaction code.

If the mobile device 220-d is disconnected from the cellular network 135-c, the mobile device 220-d may generate one or more offline transaction codes associated with the transaction using an offline transaction code key previously received from the payment authority server. The mobile device 220-d may transmit the transaction code received from the payment authority server to the merchant point of sale 225-c, which may forward the transaction code and a transaction amount (and, in certain examples, one or more other parameters related to the transaction) to the payment authority server 120-e. The transaction code receiving module 615-a may receive the transaction code and the transaction code processing module 620-a may approve or reject the transaction based on at least the received transaction code.

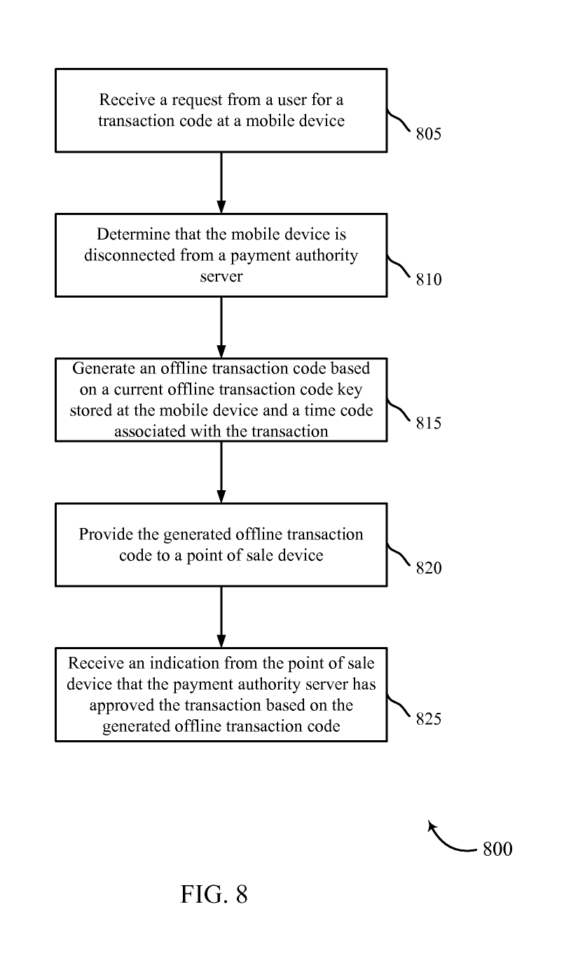

FIG. 8 depicts an example method 800 of conducting transactions at a mobile device, according to the principles of the present description. The method 800 may be performed by one or more of the mobile devices 220 described above with reference to previous Figures.

At block 805, a request may be received at the mobile device from a user of the mobile device for a transaction code. At block 810, it may be determined that the mobile device is disconnected from a payment authority server. At block 815, the mobile device may generate an offline transaction code based on a current offline transaction code key stored at the mobile device and a time code associated with the transaction. At block 820, the generated offline transaction code may be provided to a point of sale device. At block 825, an indication may be received from the point of sale device that the payment authority has approved the transaction based on the generated offline transaction code.

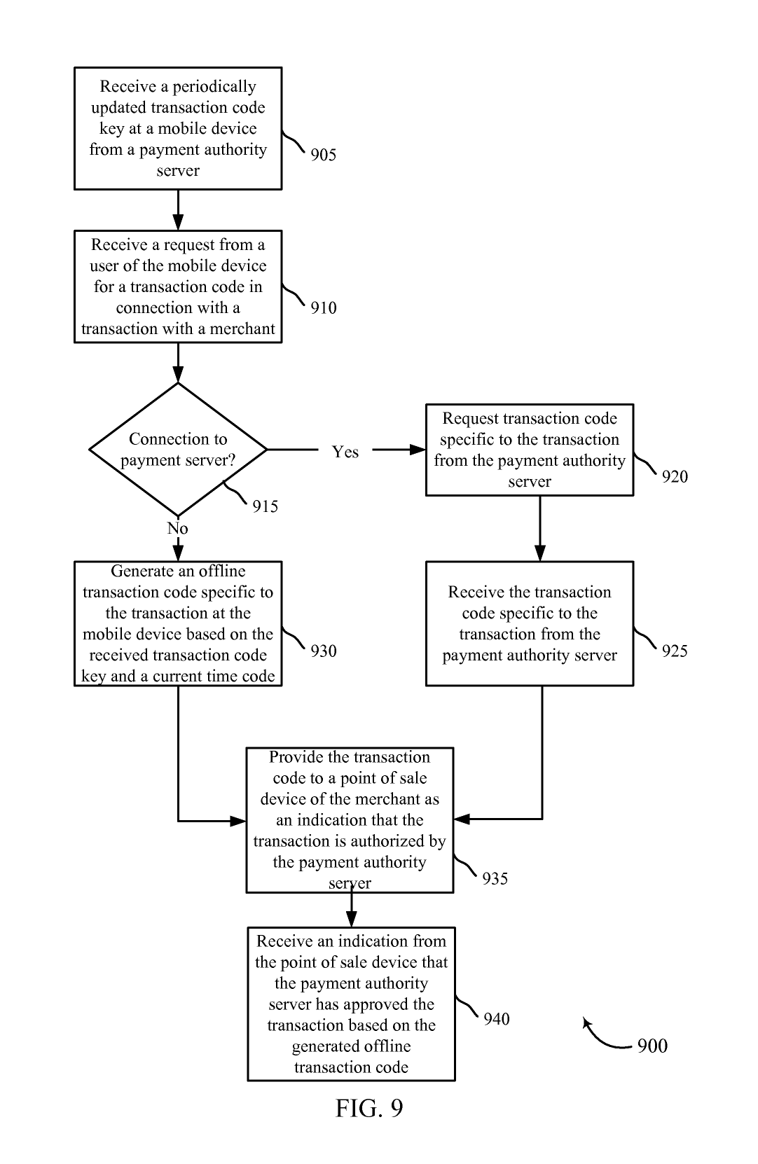

FIG. 9 depicts an example method 900 of conducting a transaction at a mobile device, according to the principles of the present description. The method 800 may be performed by one or more of the mobile devices 220 described above with reference to previous Figures. The method 900 may be an example of the method 800 of FIG. 8.

At block 905, the mobile device may receive a periodically updated transaction code key from a payment authority server. At block 910, the mobile device may receive a request from a user of the mobile device for a transaction code in connection with a transaction with a merchant. At block 915, the mobile device may determine whether the mobile device is connected to the payment authority server over a network.

If it is determined (block 915, Yes) that a connection to the payment authority server exists, the mobile device may request a transaction code specific to the transaction from the payment authority server at block 920, and at block 925, the mobile device may receive the transaction code specific to the transaction from the payment authority server. If it is determined (block 915, No) that no connection to the payment authority server exists, the mobile device may generate an offline transaction code specific to the transaction based on the received transaction code key and at least a current time code known by the payment authority server.

At block 935, the generated or received transaction code may be provided by the mobile device to a point of sale device associated with the merchant as an indication that the transaction is authorized by the payment authority server. At block 940, the mobile device may receive an indication from the point of sale device that the payment authority server has approved the transaction based on the generated offline transaction code.

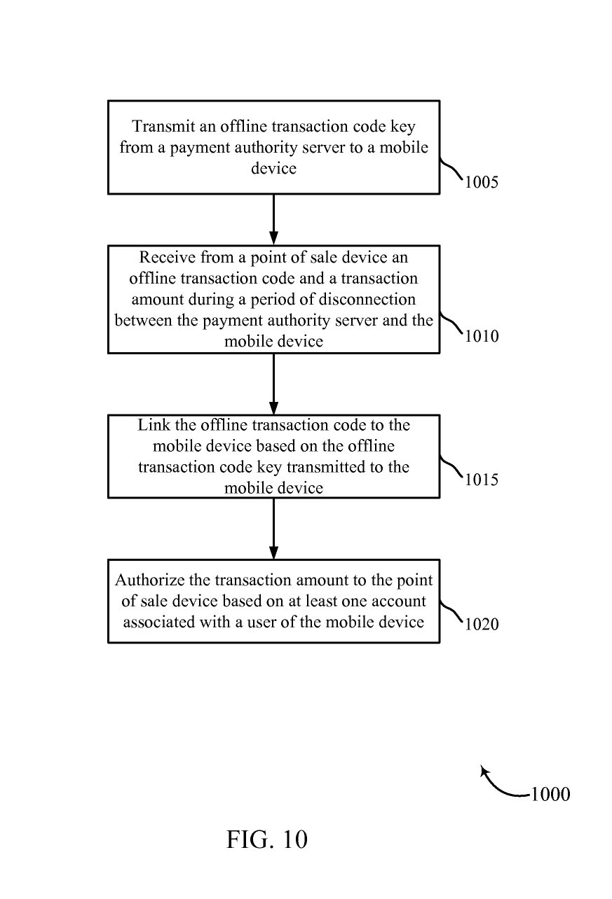

FIG. 10 depicts an example method 1000 of conducting transactions at a payment authority server, according to the principles of the present description. The method 1000 may be performed by one or more of the payment authorities 120 described above with reference to previous Figures.

At block 1005, an offline transaction code key may be transmitted from the payment authority server to a mobile device. At block 1010, the payment authority server may receive from a point of sale device an offline transaction code generated by the mobile device and a transaction amount during a period of disconnection between the payment authority server and the mobile device. At block 1015, the payment authority server may link the offline transaction code to the mobile device based on the offline transaction code key transmitted to the mobile device. At block 1020, the transaction amount may be authorized to the point of sale device based on at least one account associated with a user of the mobile device.

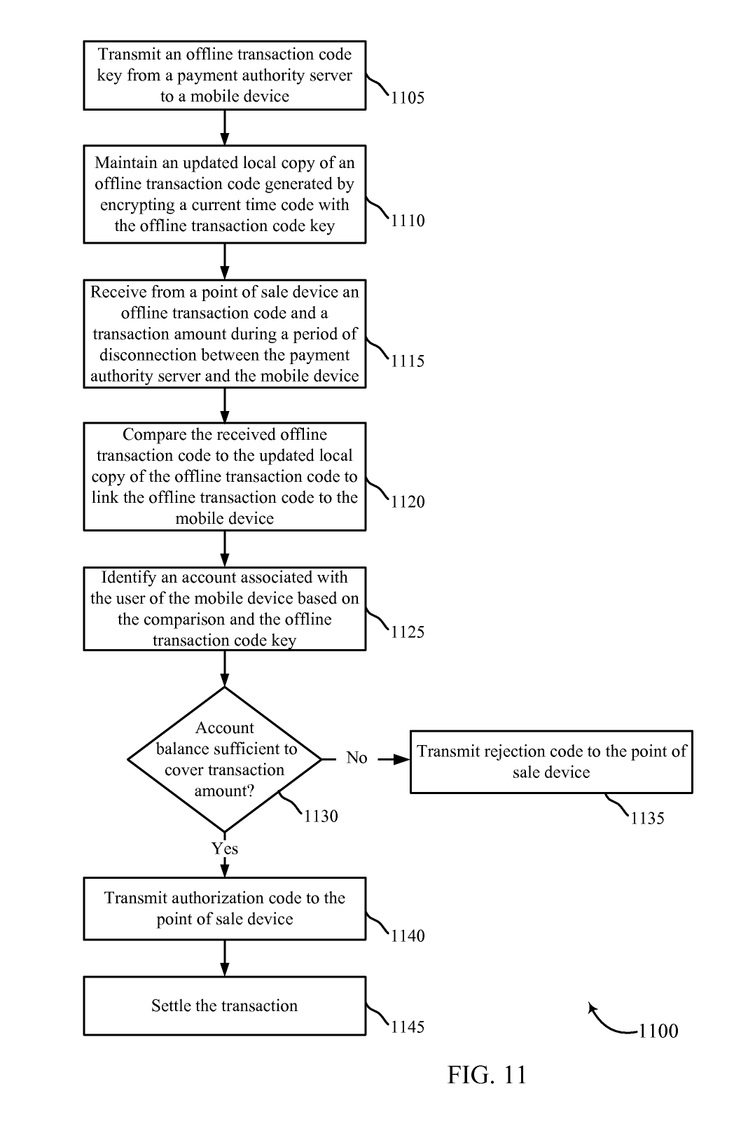

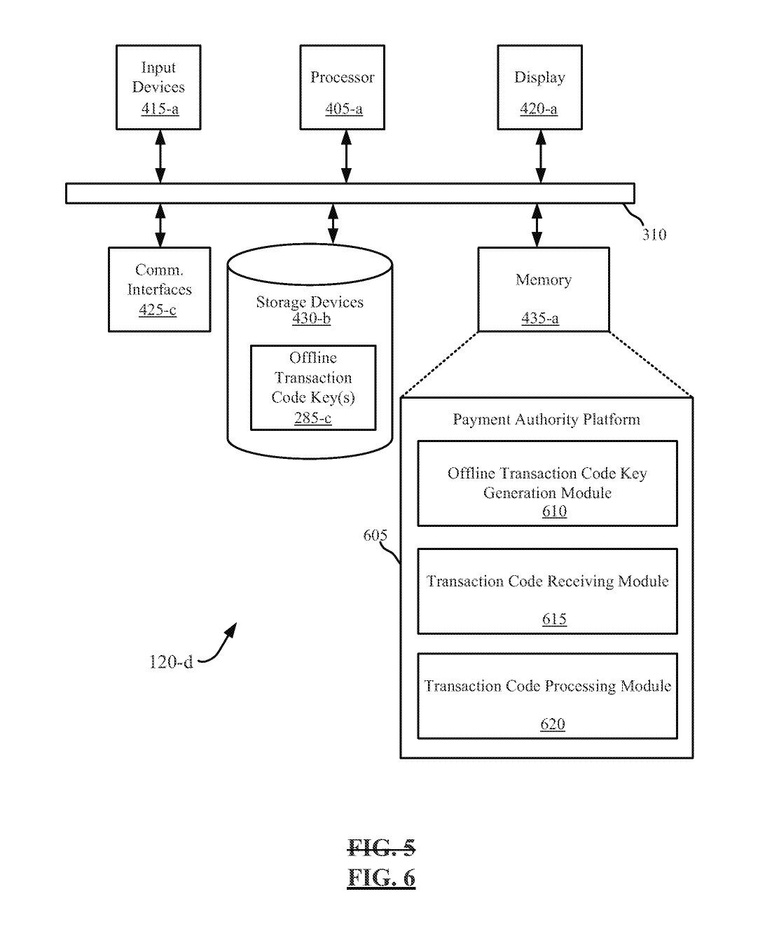

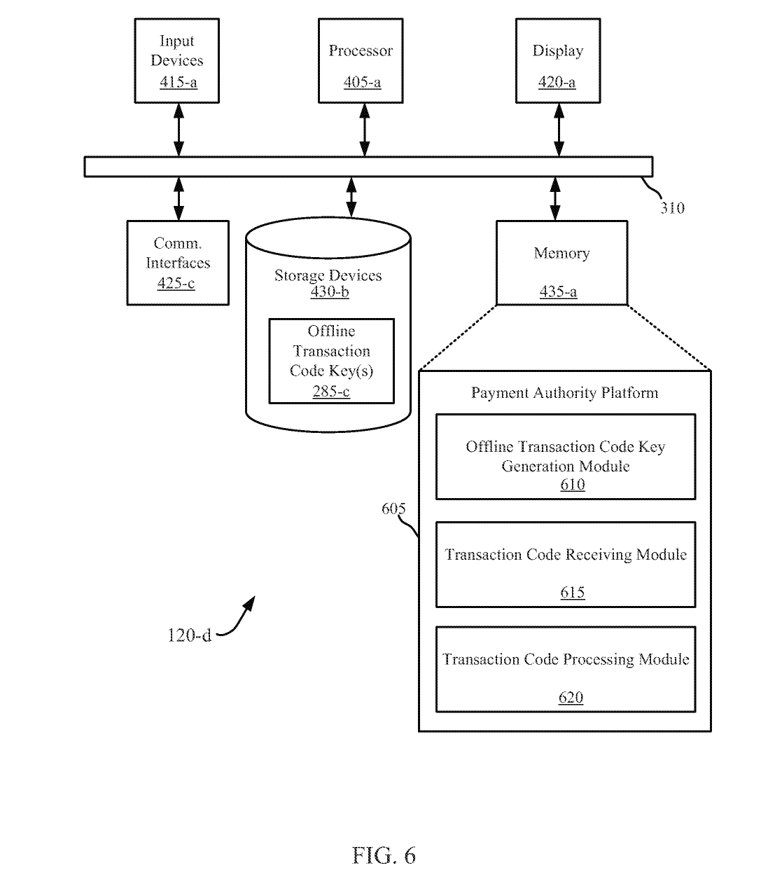

FIG. 11 depicts another example method 1100 of conducting transactions at a payment authority server, according to the principles of the present description. The method 1100 may be performed by one or more of the payment authorities 120 described above with reference to previous Figures. The method 1100 may be an example of the method 1000 of FIG. 10.

At block 1105, the payment authority server may transmit an offline transaction code key from to a mobile device. At block 1110, the payment authority server may maintain an updated local copy of an offline transaction code generated by encrypting a current time code known to the mobile device and the payment authority server with the offline transaction code key. At block 1115, the payment authority server may receive from a point of sale device an offline transaction code generated by the mobile device and a transaction amount during a period of disconnection between the payment authority server and the mobile device.

At block 1120, the payment authority server may compare the received offline transaction code to the updated local copy of the offline transaction code stored at the payment authority server to link the offline transaction code to the mobile device. At block 1125, the payment authority server may identify an account associated with the user of the mobile device based on the comparison and the offline transaction code key.

At block 1130, a determination is made of whether a balance of the identified account is sufficient to cover the received transaction amount. If so (block 1130, Yes), the payment authority server may transmit an authorization code to the point of sale device at block 1140 and settle the transaction at block 1145. On the other hand (block 1135, No), the payment authority server may transmit a rejection code to the point of sale device at block 1135.

The components described in the Figures of the present disclosure may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of conducting transactions, comprising:
receiving, at a mobile device, a request from a user for a transaction code associated with a transaction between the mobile device and a point of sale device;
generating an offline transaction code based on a current offline transaction code key stored at the mobile device and a time code associated with the transaction in response to a determination that the mobile device is disconnected from a payment authority server;
providing the generated offline transaction code from the mobile device to the point of sale device; and
receiving an indication from the point of sale device that the payment authority server has approved the transaction based on the generated offline transaction code.

2. The method of claim 1, wherein the generating the offline transaction code comprises:
encrypting the time code associated with the transaction with the current offline transaction code key.

3. The method of claim 1, further comprising:
requesting an updated offline transaction code key from the payment authority server in response to reconnecting to the payment authority server over a network.

4. The method of claim 3, further comprising:
receiving the updated offline transaction code key from the payment authority server;
marking the current offline transaction code key as expired; and
replacing the current offline transaction code key with the updated offline transaction code key.

5. The method of claim 3, further comprising:
periodically requesting new updated offline transaction code keys during a period of connectivity between the mobile device and the payment authority server.

6. The method of claim 1, further comprising:
authenticating an identity of the user at the mobile device prior to providing the generated offline transaction code to the point of sale device.

7. The method of claim 2, further comprising:
receiving an authentication credential from the user of the mobile device in connection with the request for the transaction code.

8. The method of claim 1, further comprising:
storing a separate offline transaction code key at the mobile device for each of a plurality of payment accounts associated with the user of the mobile device.

9. The method of claim 1, wherein the time code associated with the transaction is based on a current window of time.

10. The method of claim 9, wherein the offline transaction code expires at the end of the current window of time associated with the time code.

11. A method for conducting transactions at a payment authority server, comprising:
transmitting an offline transaction code key to a mobile device;
receiving, from a point of sale device, an offline transaction code and a transaction amount during a period of disconnection between the payment authority server and the mobile device;
linking the offline transaction code to the mobile device based on the offline transaction code key; and
authorizing the transaction amount to the point of sale device based on at least one account associated with a user of the mobile device.

12. The method of claim 11, further comprising:
computing a local copy of the offline transaction code at the payment authority server prior to receiving the offline transaction code from the point of sale device;
wherein the linking the received offline transaction code to the mobile device is based on a comparison of the received offline transaction code to the local copy of the offline transaction code.

13. The method of claim 12, wherein the computing the local copy of the offline transaction code comprises:
encrypting a time code associated with the transaction based on the offline transaction code key transmitted to the mobile device.

14. The method of claim 13, wherein the time code associated with the transaction is based on a current window of time.

15. The method of claim 14, further comprising:
marking the local copy of the offline transaction code as expired at the end of the current window of time associated with the time code.

16. The method of claim 11, further comprising:
transmitting a separate offline transaction code key to the mobile device for each of a plurality of payment accounts associated with the user of the mobile device.

17. The method of claim 16, wherein the authorizing the transaction amount comprises:
identifying the at least one account from the plurality of payment accounts associated with the user of the mobile device based on the received offline transaction code; and
determining whether a balance of the at least one account is sufficient to authorize the transaction amount.

18. The method of claim 11, further comprising:
transmitting the offline transaction code key to the mobile device in response to a request from the mobile device for an updated transaction code key.

19. The method of claim 11, receiving periodic requests at the payment authority server for an updated transaction code key during a period of connectivity between the mobile device and the payment authority server.

20. The method of claim 11, further comprising:
transmitting an authorization code to the point of sale device based on the authorization of the transaction amount.

21. A mobile device, comprising:
a processor;
a memory communicatively coupled with the processor, the memory storing instructions executable by the processor to:
receive, at a mobile device, a request from a user for a transaction code associated with a transaction between the mobile device and a point of sale device;
generate an offline transaction code based on a current offline transaction code key stored at the mobile device and a time code associated with the transaction in response to a determination that the mobile device is disconnected from a payment authority server;
provide the generated offline transaction code from the mobile device to the point of sale device; and
receive an indication from the point of sale device that the payment authority server has approved the transaction based on the generated transaction code.

22. The mobile device of claim 21, the memory further storing instructions executable by the processor to:
encrypt the time code associated with the transaction with the current offline transaction code key to generate the offline transaction code.

23. The point of sale device of claim 22, the memory further storing instructions executable by the processor to:
request an updated offline transaction code key from the payment authority server in response to reconnecting to the payment authority server over a network.

24. The mobile device of claim 21, the memory further storing instructions executable by the processor to:
periodically requesting new updated offline transaction code keys during a period of connectivity between the mobile device and the payment authority server.

25. A payment authority server, comprising:
a processor;
a memory communicatively coupled with the processor, the memory storing instructions executable by the processor to:
transmit an offline transaction code key to a mobile device;
receive, from a point of sale device, an offline transaction code and a transaction amount during a period of disconnection between the payment authority server and the mobile device;
link the offline transaction code to the mobile device based on the offline transaction code key; and
authorize the transaction amount to the point of sale device based on at least one account associated with a user of the mobile device.

26. The payment authority server system of claim 25, the memory further storing instructions executable by the processor to:
compute a local copy of the offline transaction code at the payment authority server prior to receiving the offline transaction code from the point of sale device;
wherein the linking the received offline transaction code to the mobile device is based on a comparison of the received offline transaction code to the local copy of the offline transaction code.

27. The payment authority server system of claim 25, the memory further storing instructions executable by the processor to:
encrypt a time code associated with the transaction based on the offline transaction code key transmitted to the mobile device to compute the local copy of the offline transaction code, wherein the time code associated with the transaction is based on a current window of time; and
marking the local copy of the offline transaction code as expired at the end of the current window of time associated with the time code.

28. The payment authority server system of claim 25, the memory further storing instructions executable by the processor to:
transmit a separate offline transaction code key at the mobile device for each of a plurality of payment accounts associated with the user of the mobile device;
identify the at least one account from the plurality of payment accounts associated with the user of the mobile device based on the received offline transaction code; and
determine whether a balance of the at least one account is sufficient to authorize the transaction amount.
